(19) United States
(12) Patent Application Publication
(10) Pub. No.: US 2025/0329767 A1
(43) Pub. Date: Oct. 23, 2025

(54) CURVED (INVOLUTE) FUEL CELL STACK PLACEMENT DESIGN

(71) Applicant: ZeroAvia, Inc., Hollister, CA (US)

(72) Inventors: Sergei Shubenkov, Cirencester (GB); Jonathan Leopold Nutzati Fontaine, Hollister, CA (US); Ilya Kosarev, Cirencester (GB)

(21) Appl. No.: 19/177,392

(22) Filed: Apr. 11, 2025

Related U.S. Application Data
(60) Provisional application No. 63/635,952, filed on Apr. 18, 2024.

(51) Int. Cl. H01M 8/2465; H01M 8/04014

(52) U.S. Cl. CPC H01M 8/2465; H01M 8/04014; H01M 2250/20

(57) ABSTRACT

Disclosed is an air-cooled fuel cell (FC) stack including a plurality of FCs arranged in a stack in a curved pattern. The plurality of FC stacks are arranged spaced from one another in a curved pattern, preferably a spiral pattern, more preferably an involute pattern. Also disclosed is an integrated FC electric engine for a vehicle such as an aircraft including a centrifugal compressor and a turbine rotatably mounted on a shaft, and one or more curved FC stacks arranged to an outside of the rotatably mounted centrifugal compressor and the rotatably mounted turbine.

### CROSS REFERENCE TO RELATED APPLICATION

This application claims benefit to U.S. Provisional Patent Application Ser. No. 63/635,952, filed Apr. 18, 2024, the contents of which are incorporated herein by reference in its entirety.

### FIELD OF THE DISCLOSURE

The present disclosure relates to fuel cell stack design, and more particularly to hydrogen fuel cell air-cooled stack design and packaging of groups of air-cooled stacks. The disclosure has particular utility in design and positioning of hydrogen air-cooled fuel cell stacks for use in powering electric engines for transport vehicles, including aircraft, and will be described in connection with such utility although other utilities are contemplated.

### BACKGROUND AND SUMMARY

This section provides background information related to the present disclosure which is not necessarily prior art. This section provides a general summary of the disclosure and is not a comprehensive disclosure of its full scope or all its features.

A fuel cell (FC) is an electrochemical cell that converts chemical energy of fuel into electrical energy by means of spontaneous electrochemical reduction-oxidation (redox) reactions. FCs include an anode and a cathode separated by an ionically conductive electrolyte. During operation, a fuel (e.g., hydrogen) is supplied to the anode and an oxidant (e.g., oxygen or air) is supplied to the cathode. The fuel is oxidized at the anode, producing positively charged ions (e.g., hydrogen ions—protons) and electrons. The protons travel through the electrolyte from the anode to the cathode, while the electrons simultaneously travel from the anode to the cathode outside the cell via an external circuit, which produces an electric current. The oxidant supplied to the cathode is reduced by the electrons arriving from the external circuit and combines with the protons to form water. As a result of the above-described exothermic reaction, additional generated heat needs to be removed from the FC.

FCs may be used as power sources for electric motors of electric vehicles and hybrid electric vehicles, including aircraft. In such applications, FCs are oftentimes arranged in stacks of multiple cells and connected in a series or parallel arrangement to achieve a desired power and output voltage. Cooling systems for FC-powered vehicles oftentimes use an airflow generated during movement of the vehicle as a heat transfer medium. For example, an ambient airflow may be directed from outside the vehicle through an air intake of the vehicle and through one or more heat exchangers disposed within the vehicle. An airflow generated in this manner is oftentimes referred to as ram air and, when ram air is used as a cooling medium in a vehicle, the vehicle may experience increased drag, which may reduce the energy efficiency of the vehicle.

Heat management processes such as heat exchangers or coolant media in high temperature polymer electrolyte membrane (HTPEM) FCs increase the overall weight and volume of the system. Improvements in cooling efficiency directly impact cost per kW and enable operation at higher altitudes.

Aviation applications require megawatt-range power and lightweight FC systems with high specific power. Air-cooling in combination with HTPEM FCs solves the problem of system weight by excluding heavy heat exchanger and liquid coolant components. However, the limited volumetric thermal capacity of air makes scaling and packaging of air-cooled stacks problematic.

Temperature gradient is also a problem with powerful air-cooled systems—even given sufficient cooling, since the first part of the FC in contact with the coolant is cooled more than later parts, resulting either in an overheated section at the end or an oversized cooling system.

To address the cooling issue, power-intensive FC systems often are made of multiple stacks requiring elongated, asymmetrical construction, which results in uneven cooling which, as noted above, is problematic. Typically, air cooling is optimized for a single stack rather than multiple stacks. Thus, prior art designs employ longitudinal-type placement or -axis-concentric unequal stack spacing. Due to geometric constraints in an aircraft body/nacelle, this causes excessive coolant pressures and uncompensated drag in long air ducts distributing cooling air and collecting hot exhaust. Additionally, the weight of reactant pipes and electrical wires increases quadratically rather than linearly with length, which causes problems in typical long, linear stack placement designs. All of the foregoing cause power inefficiencies that limit the scale-up of air-cooled HTPEM FC systems in aircraft and other power-intensive systems.

FIGS. 1A and 2 illustrate stacks 10 of fuel cells 12a, 12b, 12c . . . 12n within an aircraft nacelle 14. In the case of transportation applications, such as vehicular and aircraft, air-cooled stacks 10 are placed to fit within specific dimensions of the vehicle and, as a result, are often constrained along the coolant flow direction 16 and 16a and 16b (shown in FIGS. 4A and 4B). Longitudinal placement of stacks 12a, 12b, 12c . . . 12n, one after the other, is the existing approach when the application is both geometrically-constrained and power-intensive. The dimensions are generally defined by the ultimate length and cross-sectional area (height×width). Stack placement width is particularly critical in aviation due to air resistance, which strongly affects mobility and efficiency.

Referring to FIGS. 3 and 3A, in the prior art, in attempting to achieve uniform cooling supply to the FCs across a stack and multiple air-cooled stacks placed along the cooling flow longitudinally (as in FIG. 2), the individual stacks and the whole stack assemblies are equipped with inclined triangular cooling ducts (also shown in FIGS. 4A and 4B), known as cooling channels or confusers and diffusers (hereinafter generally referred to as “cooling ducts”). Note that every stack is equipped with two ducts—a confuser and a diffusor. As so arranged, a confuser for cooling air inflow of one stack may act as a diffuser for cooling air outflow of an adjacent stack.

Typically, the cooling ducts are tapered or triangular channels along a stack or series of stacks 10. As the triangular cooling ducts run along the stacks 10, they decrease in cross-section 18c as the cooling air flows into the stacks and end at the last stack in the row. These triangular ducts are shown in FIG. 3, where two large triangular cooling ducts, one for inflow 18a and one for outflow 18d, run along a row of stacks 10, and smaller triangular cooling ducts for inflow 18b and outflow 18e (see FIG. 3A) run between the stacks 10.

The cooling ducts preferably are rectangular in cross-section in order to provide a substantially uniform distribution of the cooling airflow rate through the stack in the plane of this cross-section, i.e., as shown in FIG. 3. In the cooling ducts designed to be inclined and triangular (and rectangular cross-section), inlet/outlet dimensions may be optimized with respect to total stack cross-sectional area to the extent to which placement of reactant pipes and electrical wires allows for the system-dependent pressure- and voltage-drop constraints.

This prior art design of inclined, rectangular HTPEM air-cooled stacks separated by inclined, triangular cooling ducts has serious draw backs. Firstly, it is challenging to provide equal pressure drops in the inlet and outlet ducts in all ambient conditions because both volumetric airflow rate and, thus, pressure drops depend on air temperature. If the air inlet temperature varies widely, for example, with altitude change, then pressure drops in the inlet cooling ducts would vary, even in the case of constant gravimetric airflow rate, due to thermal expansion effects on air flow velocity. Since outlet temperature does not depend on ambient conditions, the volume of cooling air supplied to the stack non-linearly depends on ambient temperature while exhaust air flow depends on temperature linearly. This would cause uneven cooling air distribution across the stack cross-sectional area and furthermore would lead to different pressure drops and thus different cooling flow rates between stacks, which is a critical problem for a system built on air-cooled HTPEM stacks.

For example, if there is a 10% variation in cooling airflow between stacks producing equal heat power, this would lead to 10% variation in cooling air ΔT between stacks, which is commercially impractical in case of high ΔT. For a typical 150° C. average temperature difference between HTPEM FC inlet and outlet cooling air temperature, a 10% variation in airflow would mean a 150° C. variation in operating temperatures within a stack because the inlet temperature is the same for all stacks in one construction. This 150° C. raise would have a significant effect on the performance and reliability of stacks and poses a critical issue for the system, especially for stacks electrically connected in series.

Another drawback of prior art stack arrangements with long constructions and “longitudinal”-type stack placement is that, for very long constructions, the dependence between the length of the construction and the volume of cooling ducts 18 becomes non-linear (quadratic) because their cross-section area is linearly dependent on the length (see FIGS. 4A and 4B) and, in some embodiments, the cooling ducts may be even wider in order to maintain low pressure drop of cooling flow. Since the cooling duct cross-sectional area should be of rectangular shape to enable energy efficient cooling, the cross-sectional area requirement can be considered as the requirement for one dimension of the inlets shown in FIGS. 4A and 4B.

While it may seem favorable to minimize cooling duct volume from a weight perspective, cooling ducts that are too small could create pressure drops that would reduce cooling efficiency. For example, for an HTPEM stack with a 150° C. temperature gradient of cooling flow inside the stack and efficiency of 40%, a cooling duct cross-sectional area smaller than 10% of the stack cross-sectional area would create pressure drops in the duct greater than 300-500 Pa. Such large pressure drops would not be acceptable in terms of efficiency. Therefore, in case of a long construction with sequential air supply, both cross-sectional area and cooling duct length need to be increased, meaning that the cooling duct volume quadratically (at least) depends on the number of stacks. If using incoming flow and fans for cooling, the high pressure drops can lead to uncompensated drag equivalent to over 5% of generated power.

Another recurring issue in prior art stack arrangements is that of long connection reactant pipes and electrical wires because the weight of pipes and wires increases quadratically, not linearly, with length. This challenge arises from the extended length in the longitudinal design, given the effect of length and cross-sectional area on reactant pipe pressure drops and electrical wire voltage drops. For example, the weight of a five-meter pipe easily may be comparable with the entire stack weight because of the diameter of the cathode air pipe.

Summarizing to this point, aircraft typically have extended fuselages and nacelles, causing the placement of stacks along walls to appear very natural at first glance. However, building a long rather than wide stack system tends to result in a system that is both long and wide, as well as heavy, due to the electrical connections, cathode air connections, and coolant flow ducts. To address this consideration, one possibility is to provide an integrated FC electric engine comprising a compressor (e.g. centrifugal, axial, etc.) and a turbine rotatably mounted, back-to-back on a common shaft, and arranging FCs around an outside of the rotatably mounted turbine in accordance with the teachings of our co-pending U.S. Provisional Application Ser. No. 63/532,871, filed Aug. 15, 2023, the contents of which are incorporated herein in their entirety by reference. Another possibility is to make the stack construction 10a as short as possible, as shown in FIG. 1B in contrast with FIG. 1A. However, this latter stack geometry may be challenging to fit within an aircraft's extended fuselages or nacelles.

In accordance with the present disclosure, we arrange FCs in involute-shaped stacks (see FIG. 5) and arrange the stacks around an axis of cooling airflow in a curved, spiraled, or involute pattern (see FIGS. 7 and 8) so that FCs are evenly spaced with constant spaces between them, which enables uniform cooling flows across stacks and equal cooling flow for all stacks. The resulting air-cooled HTPEM stack design and arrangement enables a more uniform coolant supply, as well as more compact, lightweight, and energy efficient stack construction.

More particularly, in accordance with the present disclosure, we arrange our FCs in involute-shaped stacks and arrange the involute-shaped stacks in a circle to fit within an aircraft nacelle or fuselage. In a particularly preferred embodiment, the stacks are arranged to be cooled from a compressor or propulsor and especially in cases of rotating airflow (see FIG. 6). Stacks are arranged within an aircraft nacelle or fuselage, aligned along the involutes of a circle. This design provides a most compact system with gaps in-between stacks that have constant dimensions for air to penetrate equally between adjacent stacks.

In accordance with one embodiment, a stack system is split into smaller bundles (e.g., 2 or 3 bundles) with each stack having separate cooling flows (separate inlets and outlets) with the possibility of sharing any of the other flows and connections. This allows compactifying the cooling ducts and minimizing system volume and weight.

In accordance with another embodiment, triangular cooling ducts are provided, separating inflows and outflows of cooling air of the involute-shaped stacks.

According to Aspect A, there is provided a FC stack comprising a plurality of FCs arranged in a stack in a curved pattern.

According to Aspect B, there is provided a plurality of FCs arranged in stacks in curved patterns spaced from one another.

In one embodiment of Aspect B, the FC stacks are arranged in a spiral pattern.

According to Aspect B1, there is provided a plurality of FC stacks comprising a plurality of FCs arranged in a stack, wherein the FC stacks are arranged in multi-pointed star pattern.

In one embodiment of Aspect B1, the FC stacks are arranged in a multi-pointed flat-sided star pattern.

In another embodiment of Aspect B1, the FC stacks are arranged in a multi-pointed curved-wall star pattern.

In another embodiment of Aspect B, the FC stacks are arranged in an involute pattern.

In another embodiment of Aspect B, the FC stacks are evenly spaced from one another.

In a further embodiment of Aspect B, cooling ducts are provided between adjacent stacks.

In yet another embodiment of Aspect B, the cooling ducts comprise tapered cooling ducts.

In a further embodiment of Aspect B, the tapered cooling ducts comprise triangularly-shaped cooling ducts.

Still yet another embodiment of Aspect B, the FCs comprise hydrogen fuel cells.

According to Aspect C there is provided an integrated FC electric engine comprising a compressor and a turbine rotatably mounted on a shaft; with one or more FC stacks as above described, arranged to an outside of the rotatably mounted compressor and the rotatably mounted turbine.

According to one embodiment of Aspect C, the FCs comprise hydrogen FCs.

According to another embodiment of Aspect C the FCs comprise hydrogen FCs configured to be cooled from air flow.

According to a further embodiment of Aspect C, the cooling airflow includes airflow for the FCs from the rotatably mounted centrifugal compressor.

According to Aspect D, there is provided a hydrogen FC-powered vehicle comprising an integrated hydrogen FC electric engine as above described.

According to one embodiment of Aspect D, the vehicle comprises an aircraft.

According to another embodiment of Aspect D, the integrated hydrogen FC electric engine is mounted within a fuselage or a nacelle of an aircraft.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Further features and advantages of the disclosure will be seen in the following detailed description, taken in conjunction with the accompanying drawings wherein like numerals depict like parts. The drawings described herein are for illustrative purposes only of selected embodiments, and not all possible implementations, and are not intended to limit the scope of the present disclosure.

In the drawings:

FIGS. 1A and 1B are perspective views of stacks in accordance with the prior art;

FIG. 2 is a perspective view of a FC-powered propulsor installed in a nacelle of an airplane in accordance with the present prior art, details of the electric engine being omitted from a standpoint of simplicity;

FIG. 3 is a cross-sectional view of longitudinal construction of stacks, and FIG. 3A a close-up perspective view of a stack and cooling ducts in accordance with the prior art, highlighting the rectangular cross-section;

FIGS. 4A and B are perspective views of stack and cooling duct arrangements in accordance with the prior art, FIG. 4A is a row of 3 stacks and FIG. 4B an individual stack;

FIG. 5 is a plan view depicting involutes of a circle structure in accordance with the prior art;

FIG. 6 is a simplified cross-sectional view of positions of an integrated hydrogen FC electric engine in accordance with the present disclosure;

FIG. 7 is a plan view of a stack in an integrated hydrogen electric FC engine in accordance with the present disclosure;

FIG. 8 is a perspective view of a stack in accordance with the present disclosure;

FIG. 9 is a perspective view of the stack of FIG. 8, installed in a nacelle of an airplane;

FIG. 10 is a schematic depiction of an aircraft incorporating a stack in accordance with the present disclosure;

FIG. 11 is a plan view of a multi-pointed flat-sided star pattern arrangement of FCs in accordance with another embodiment of the present disclosure;

FIG. 12A is a plan view and FIG. 12B is a perspective view of a multi-pointed curved-sided star pattern in accordance with yet another embodiment of the present disclosure.

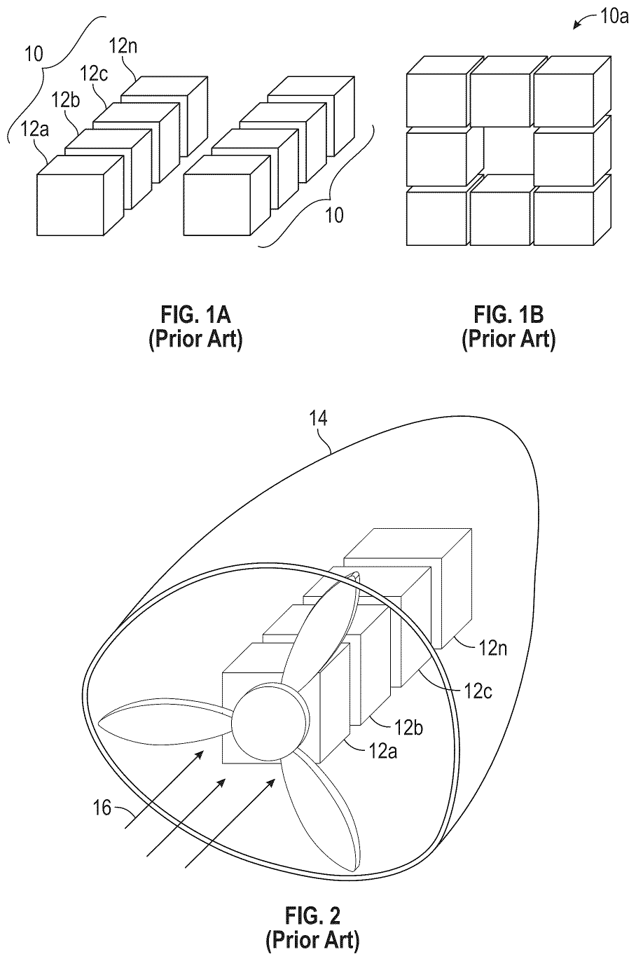

### DETAILED DESCRIPTION

Example embodiments will now be described more fully with reference to the accompanying drawings. Example embodiments are provided so that this disclosure will be thorough and will fully convey the scope to those who are skilled in the art. Numerous specific details are set forth such as examples of specific components, devices, and methods to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, components, and/or groups, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer, or section. Terms such as “first,” “second,” and other numerical terms when used herein do not imply a sequence or order unless clearly indicated by the context. Thus, a first element, component, region, layer, or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present disclosure is based on arranging FCs in a curved stack having a structural profile of an involute of a circle. The involute-shaped stacks are spaced from one another around a circle. An involute is a type of curve that is dependent on another shape or curve, in this case, a circle. An involute of a curve can be considered as the locus of a point on a piece of taut string as the string is either unwrapped from or wrapped around the curve. Mathematically, an involute, illustrated in FIG. 5, is represented as follows:

For a circle with parametric representation:

$$( r cos ( t ) , r sin ( t ) )$$

$$one has {{\to }_{C}}^{′} ( t ) = ( - r sin t , r cos t ) .$$

$$Hence , {{\to }_{C}}^{′} ( t ) = r , and the path length is r ( t - a ) .$$

Evaluating the above given equation of the involute, one gets

$$X ( t ) = r ( cos ( t + a ) + t sin ( t + a ) )$$

$$Y ( t ) = r ( sin ( t + a ) + t cos ( t + a ) )$$

for the parametric equation of the involute of the circle (see again FIG. 5).

The a term is optional; it serves to set the start location of the curve on the circle. The involutes look like Archimedean spirals, but they are actually not.

The arc length for a=0 and 0≤t≤t₂ of the involute is

$$L = \frac{r}{2} {t}_{2}^{2} .$$

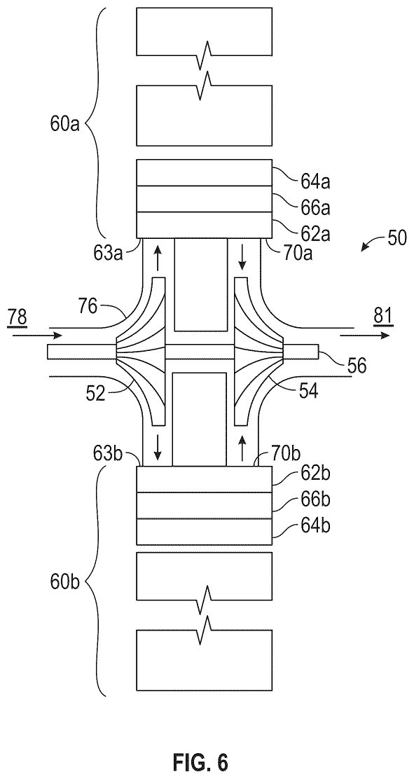

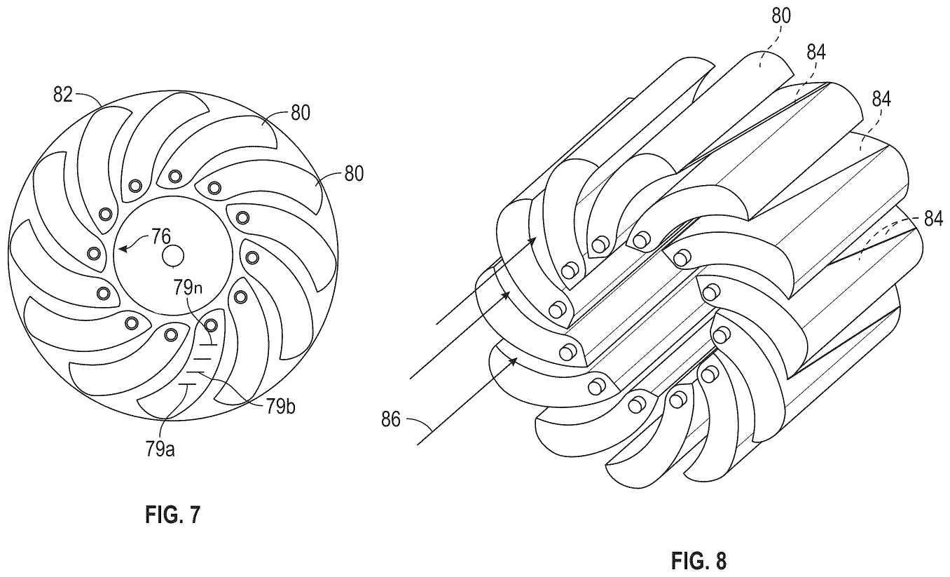

Referring to FIGS. 6, an integrated hydrogen FC electric engine 50 in accordance with present disclosure includes a centrifugal or axial compressor 52 and a turbine 54 rotatably mounted on a common shaft 56. Compressor 52 and turbine 54 are mounted back-to-back on common shaft 56. A plurality of FCs 60a, 60b are arranged in curved stacks, as will be described below, around the outside of the compressor-turbine combination, with the fuel cell cathodes 62a, 62b facing toward the inside, i.e., facing shaft 56 and arranged so that air flows from compressor 52 into the cathode inlets 63a, 63b on the cathode side of the FCs 60a, 60b, and anodes 64a, 64b facing toward the outside. HTPEM 66a, 66b are positioned between the anodes 64a, 64b and the cathodes 62a, 62b. Air introduced on the cathode side of the FCs 60a, 60b reacts with hydrogen (H₂) gas introduced on the anode side of the FCs 60a, 60b producing electricity and a cathode reactant gas stream comprising primarily warm air and water. The cathode reactant gaseous stream is then passed via cathode outlets 70a, 70b through turbine 54 to extract mechanical work from the stream of warm moist air. The compressor 52 and turbine 54 assembly is housed within an annular duct 76 which includes an air inlet 78 configured for uninterrupted axial delivery of air flow to the compressor 52, and exhaust of spent air via an air exhaust outlet 81 from the turbine 54.

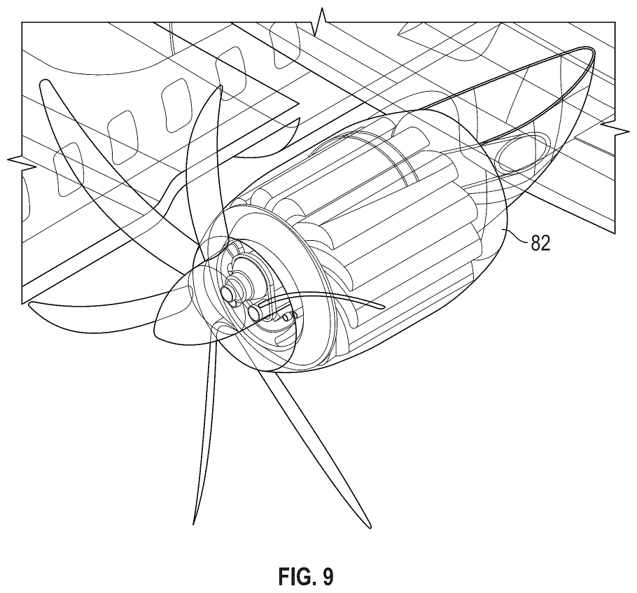

Referring to FIGS. 7 and 8, a plurality of FCs 79a, 79b, 79n are arranged in stacks 80 around annular duct 76 within a nacelle 82 of the aircraft. Each stack 80 has essentially identical curved shape in the form of an involute. Triangular shaped cooling ducts 84 are located between the curved stacks 80. Ducts 84 are tapered to run along the lengths of the stacks 80, decreasing in cross-section from the proximal end where cooling air 86 flows into the stacks and ends at the distal ends of the stacks 80. Referring to FIG. 9, the stack is packaged within the nacelle 82 of an aircraft.

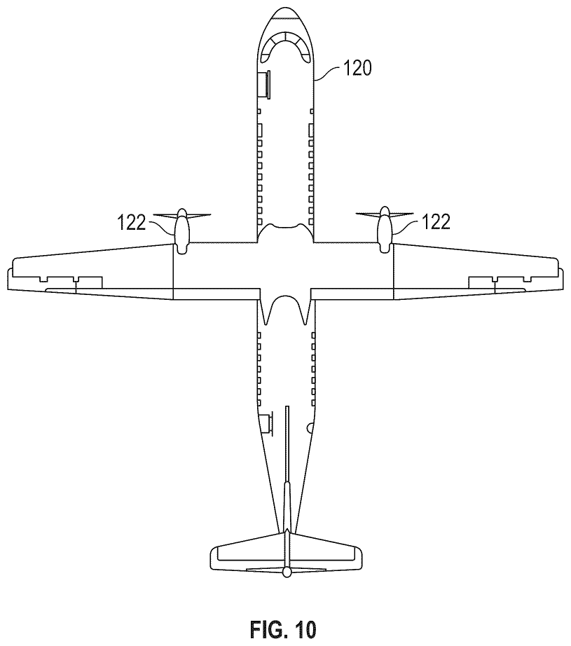

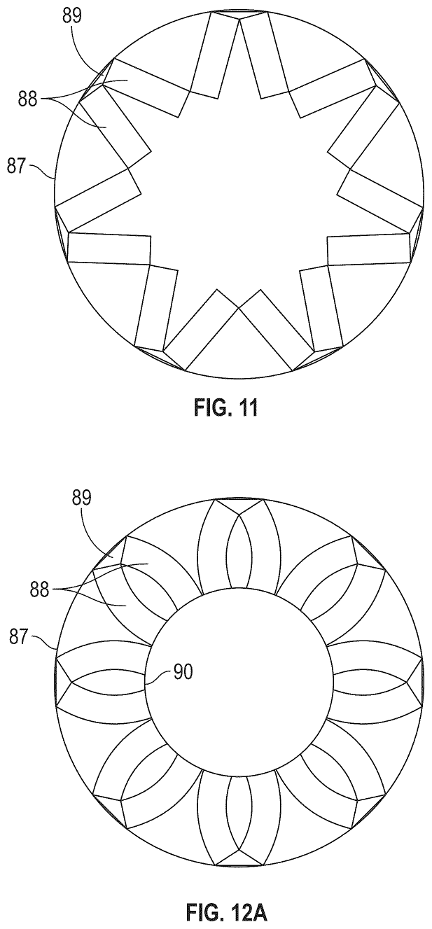

FIG. 10 illustrates an aircraft 120 including a pair of integrated hydrogen gas FC electric engine systems 122 incorporating involute shaped stacks in the aircraft nacelles in accordance with the present disclosure.

Various changes may be made in the foregoing disclosure. For example, one possibility is to split a system into smaller subsystems (e.g., 2 or 3 subsystems) with separate cooling flows (separate inlets and outlets). This would allow compactifying the cooling ducts and minimizing the system volume and weight.

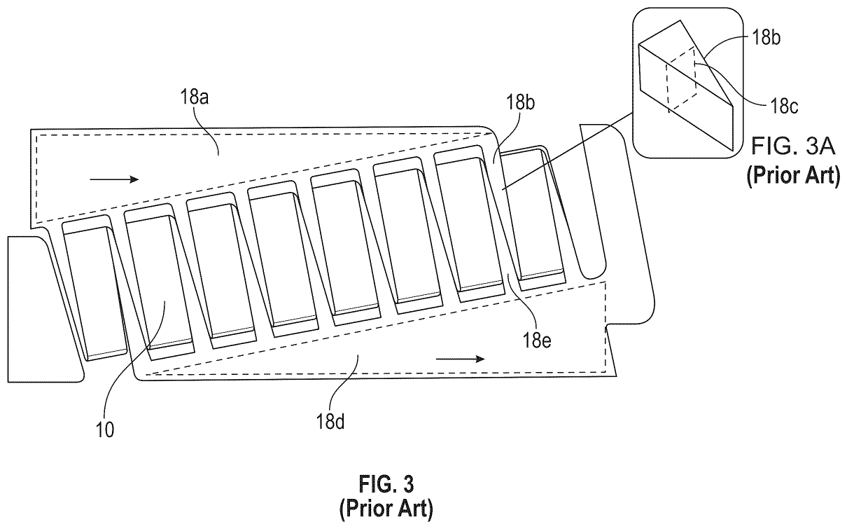

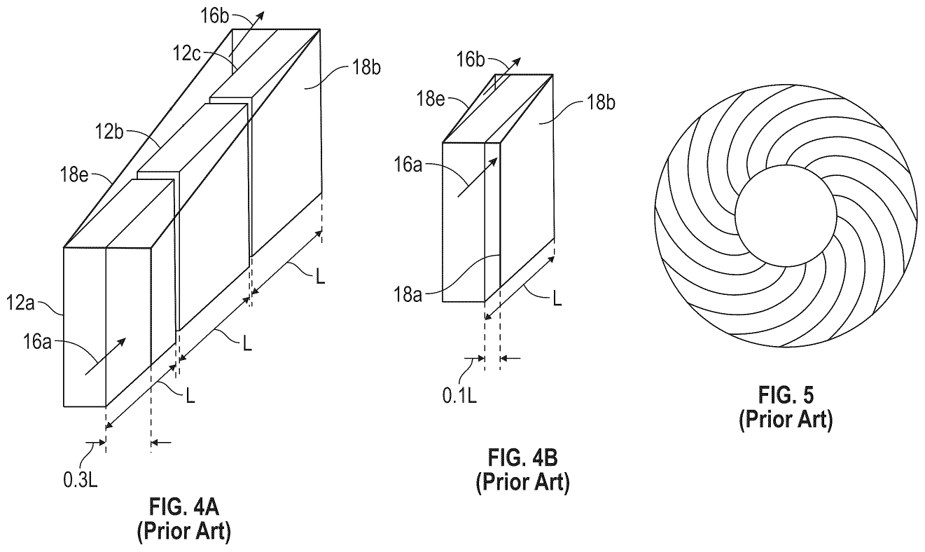

Another possibility is to include the triangular cooling duct walls separating inflows and outflows of cooling air. This design would follow the same ratios shown in prior art FIGS. 3 and 4, length L of stack to 0.1 L width of cooling duct incline but implemented within the new curved (involute) stack configurations. FIG. 8 shows the walls between cooling ducts inclined from the inlet to outlet so that the cross-sectional area gradually decreases along the incoming flow and increases along the outgoing flow.

The proposed stack arrangement is significant in achieving desired compactness to be able to occupy minimum dimensions, e.g., when retrofitting the nacelle of an existing aircraft as shown in FIG. 9. It also provides aerodynamic (round) shape in case of specially designed nacelle for the stack arrangement. The curved shape of stacks improves their mechanical properties and stability especially in vibrative conditions of aircraft.

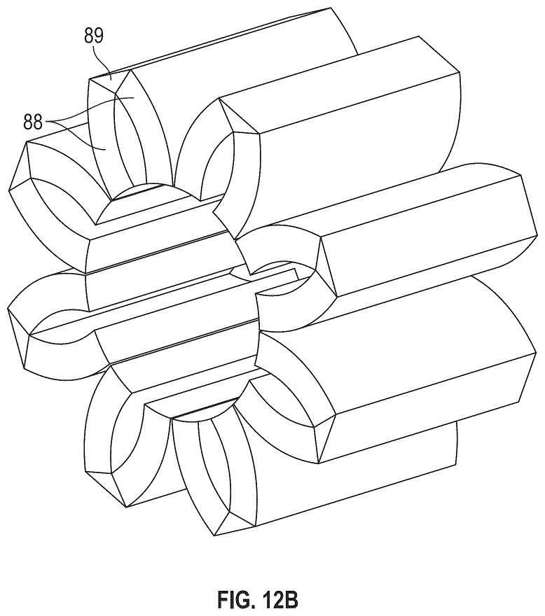

In other applications with different HTPEM stack specific power requirements, other embodiments shown in FIGS. 11, 12A and 12B can include multi-pointed flat-sided or multi-pointed curved-sided star patterns 89 where stacks 88, either flat or curved, make contact with each other at two points, once at the edge 87 the casing and once on the inner space 90 of the casing, forming a star-like pattern to enhance surface area of cooling air exchange.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Various changes and advantages may be made in the above disclosure without departing from the spirit and scope thereof.

### LIST OF REFERENCES

10 stacks
10a stack construction
12a . . . 12n fuel cells
14 nacelle
16, 16a, 16b coolant flow direction
18a inflow cooling duct
18b inflow cooling duct
18c cross section
18d outflow cooling duct
18e outflow cooling duct
50 FC electric engine
52 compressor
54 turbine
56 common shaft
60a, 60b fuel cells
62a, 62b cathodes
63a, 63b cathode inlets
64a, 64b anodes
66a, 66b HTPEM
70a, 70b cathode outlets
76 annular duct
78 air inlet
79a, 79b fuel cells
80 stacks
81 exhaust outlet
82 nacelle
84 cooling ducts
86 cooling air
87 edge
88 stacks
89 star patterns
90 inner space
120 aircraft
122 FC electric engine systems

What is claimed:

1. A fuel cell (FC) stack comprising a plurality of FCs arranged in a stack in a curved pattern.

2. A plurality of FC stacks as claimed in claim 1, arranged spaced from one another in a curved pattern.

3. The plurality of FC stacks of claim 2, wherein the FC stacks are arranged in a spiral pattern.

4. The plurality of FC stacks of claim 2, wherein the FC stacks are arranged in an involute pattern.

5. A plurality of FC stacks comprising a plurality of FCs arranged in a stack, wherein the FC stacks are arranged in a multi-pointed star pattern.

6. The plurality of FC stacks of claim 5, wherein the stacks are arranged in multi-pointed flat-sided or multi-pointed curved-sided star patterns.

7. The plurality of FC stacks of claim 2, wherein the FC stacks are evenly spaced from one another.

8. The plurality of FC stacks of claim 2, further comprising cooling ducts between adjacent stacks.

9. The plurality of FC stacks as claimed in claim 8, wherein said cooling ducts comprise tapered cooling ducts.

10. The plurality of FC stacks as claimed in claim 9, wherein the tapered cooling ducts comprise triangularly-shaped cooling ducts.

11. The plurality of FC stacks as claimed in claim 2, wherein the FCs comprise hydrogen FCs.

12. An integrated FC electric engine comprising a compressor and a turbine rotatably mounted on a shaft with one or more FC stacks as claimed in claim 2, arranged to an outside of the rotatably mounted compressor and the rotatably mounted turbine.

13. The integrated hydrogen FC electric engine of claim 12, wherein the FCs comprise hydrogen FCs.

14. The integrated hydrogen FC electric engine of claim 13, wherein the hydrogen FCs are configured to be cooled from air flow.

15. The integrated hydrogen FC electric engine of claim 14, wherein the cooling airflow includes airflow from the rotatably mounted centrifugal compressor.

16. A hydrogen FC-powered vehicle comprising an integrated hydrogen FC electric engine as claimed in claim 12.

17. The hydrogen FC-powered vehicle as claimed in claim 16, wherein the vehicle comprises an aircraft.

18. The hydrogen FC-powered aircraft of claim 17, wherein the integrated hydrogen FC electric engine is mounted within a fuselage or a nacelle of the aircraft.
